(19) United States
(12) Patent Application Publication
(10) Pub. No.: US 2007/0089899 A1
(43) Pub. Date: Apr. 26, 2007

(54) Mica tape having maximized mica content

(76) Inventors: Jonathan W. Roberts, Arlington, VA (US); Dana J. Rackliffe, Rutland, VT (US); Daniel R. Bernatchy, Bridgewater Corners, VT (US); Michael Rabar, Graz (AT)

Correspondence Address: HESLIN ROTHENBERG FARLEY & MESITI PC, 5 COLUMBIA CIRCLE, ALBANY, NY, 12203, US

(21) Appl. No.: 10/559,584

(22) PCT Filed: Sep. 3, 2004
(86) PCT No.: PCT/US04/28949

§ 371 Date: Dec. 2, 2005

Related U.S. Application Data
(60) Provisional application No. 60/548,489, filed on Feb. 25, 2004.

(51) Int. Cl. H01B 7/00; B32B 5/02; B32B 17/02; B32B 15/02; B32B 27/04

(52) U.S. Cl. 174/120 SR; 428/406; 442/149; 442/301; 442/172; 442/175; 442/180

(57) ABSTRACT

An electric insulating material according to the invention is composed of a glass fiber layer with a mica layer disposed thereon. The glass fiber layer includes twist-free glass yam. It may be a woven glass fabric. The material is particularly suitable for insulating electrical conductors such as wire suitable for use in high temperature environments, and coils for use in high voltage electrical motors and generators.

### CROSS-REFERENCE TO RELATED APPLICATIONS

This application claims priority from U.S. Provisional Application Ser. No. 60/580,489, filed on Jun. 16, 2004, the entire contents of which are each incorporated herein by reference.

### BACKGROUND OF THE INVENTION

Insulating electrical conductors in electrical apparatus has undergone significant improvement since the development of the early machines of the nineteenth century. As demands were made to supply larger and more efficient machines for industrial and commercial application, the insulation systems employed by designers has evolved to provide more withstand strength and yet occupy less space in the machine. It is to be remembered that most electrical machines are made of an electrically conductive material, a magnetic material and an insulation system. Basically, the magnetic material and the electrical conducting material are the two active materials that determine the machine performance and output capability and the insulation is only present to assure that the electricity flows only in predetermined paths. Thus, the required insulation should occupy a minimum of space and yet provide the necessary insulation between adjacent electrical conductors, and between conductors and any adjacent materials which are at ground potential.

In the past, electrical machines have traditionally used varnish, enamel compounds or glass wrap to coat individual conductors to supply the required primary strand or “turn to turn” insulation for individual conductors. In rotating machines especially, the above conductors are wound into coils, and each coil is provided with a second insulating medium, and this insulation takes the form of an insulating tape or wrapper wrapped around the group of individual conductors which have been formed into a predetermined shape to form a coil. The varnishes that functioned satisfactorily in the earlier lower voltage machines gradually were surpassed by enamels, and more recently by polymeric materials such as polyesters, polyesteramides, polyesteramideimides and polyimides to mention only a few commercially available conductor coatings.

Coil insulation has evolved from cotton tape wrapped in layers in a lapped fashion to provide the necessary insulation to an asphaltic insulation which comprised lapping coils with a tape coated with a petroleum based compound which subsequently was coated with a layer of mica flakes. The mica flakes provided an insulation resistance to a phenomena generally known as “corona” which tends to be more problematic as operating voltage levels of the rotating machines were increased. Gradually, glass fiber tapes came to be used as a carrier for mica flakes and a host of polymeric materials were used to provide the adhesive forces necessary to keep the flakes of mica in place on the tape. These are commonly known as mica tapes.

In one process for insulating coil is to wind the coil by conventional lap winding techniques and subsequently place it in a coil forming device. A vacuum-pressure-impregnating (VPI) process is employed to impregnate the taped coil with a suitable insulation material such as an uncured polymeric material to fill all the voids and interstices in the lapped insulation, and the coil is heated to cure the composite coil and insulation by a polymerization process. An alternative process for insulating coils of electric machines is to wind the coil or strands with a layered tape which has been liberally covered with a “B” stage polymeric resin in a standard lapping fashion, until the desired number of laps have been applied to the coil or strand and then apply heat and pressure at a temperature ranging from about 160° C. to about 180° C. to the coil or strand to drive the polymeric material to gelation. During the heating and pressing operation, the viscosity of the “B” stage polymeric material initially drops and excess resin is squeezed from the coil by the press employed to give the coil its final shape.

The mica tape differs in composition according to which process is used to fabricate the insulated coil. For VPI processes, tapes that have a relatively low resin content are used. The tapes are very flexible, non-adhesive and dry tapes and are distinguished by exceptional absorption capacity. They are consequently used for high-voltage machines (up to 1000 MVA). To prepare tapes that are capable of being impregnated, a mica paper may be impregnated with an epoxy resin in solvent medium and then combined with a support. Alternately, a solid resin may be dusted either on a mica sheet or directly onto the support, and then the two components may be laminated together under pressure and heat. Resin content is typically between 3% and 25%, based on the total weight of the tape. For non-VPI processes, tapes are typically made up of mica paper that is highly impregnated with an epoxy resin. Resin content is usually between 25% and 50% relative to the total weight of the tape. During manufacture, the epoxy resin is partially cured to the B stage.

In high-voltage generators, such as are used for generating electricity, or high-voltage motors, increasingly demanding requirements for the withstand voltage of any given material for the insulation are leading to an increase in the thickness of the insulation and in the number of wound layers. However, as the thickness increases, the heat transfer between the winding and the laminated stator core deteriorates at the same time, and this leads to problems in the dissipation of heat losses. Furthermore, for any given stator geometry, the winding must be designed with a smaller conductor cross section, thus resulting in a reduction in the power generated. Accordingly, one object of the invention is to provide an improved insulating material that has both improved dielectric utilization (withstand voltage) and improved thermal utilization (heat resistance).

### SUMMARY OF THE INVENTION

It has been unexpectedly discovered that a mica/glass composite based on a glass fiber layer composed of twist-free yam has improved insulating properties when used in large electrical machines or to insulate wire at very high temperature. In one aspect, then, the present invention relates to an electric insulating material that includes a glass fiber layer and a mica layer disposed thereon, where the glass fabric includes a twist-free yam.

### DETAILED DESCRIPTION

The present invention relates to an electric insulating material that includes a glass fiber layer and a mica layer disposed on the glass layer, and the glass fiber layer is composed of a twist-free yam. The glass fiber layer may be a glass fabric, especially a woven fabric, or may be a layer of parallel glass filaments or strands. In a preferred embodiment, the electric insulating material is a mica tape.

Glass fibers for use in the electric insulating material of the present invention is composed of twist-free, also called untwisted or zero-twist glass, yarn, as described in U.S. Pat. No. 6,581,257, to Burton et al., the entire contents of which are incorporated herein by reference. The patent discloses a process for making a warp beam of untwisted strands. In a conventional process that produces twisted yarn, the yarn package holder is fixed so that the yarn revolves around the outside or the inner circumference of the package, and a twist is imparted to the yarn. In the process of the Burton patent, the yarn package is rotated at the line speed of the operation. The yarn is paid out in a manner such that the yarn bundle does not rotate and impart a twist to the yarn. This yarn can be used to weave a fabric that is thinner and stronger, while yielding products with improved electrical and thermal properties compared to conventional glass fabrics composed of twisted yams.

The twist-free yarn is ribbon-like, rather than rope-like, as for conventional twisted yarns, and yields a flatter, thinner fabric with a smooth surface. Fibers that make up the yarn are typically only about 5 microns in diameter. The process for making a fabric from twist-free yarn also differs from conventional processes for weaving glass yarn in that the final fabric finish may be applied when the fibers are unwound from the package. This results in a cleaner fabric that is at least as strong as fabrics made from conventional yarns.

The glass fiber layer is typically a woven glass fabric, but non-woven fabrics may be used where the fabric is sufficiently strong and thin. Filaments or strands composed of untwisted yarn may also be used in the glass fiber layer; in this case, the electric insulating material of the present invention is a filament-type mica tape. A woven fabric that is particularly suitable for use in the electric insulating materials of the present invention is available from Dielectric Solutions, East Butler, Pennsylvania under the trade name GlasFab® Direct as fabric style 1297 or 1299.

Electric insulating materials, and particularly mica tapes, composed of twist-free glass yarn offer significant advantages that are not readily achieved with traditional twisted yarns, especially as insulation for coils of high temperature high voltage electric motors and wires for use in high temperature environments. These advantages include higher mica content in the tape for the same thickness as conventional tapes, or a thinner insulation for the same mica content, high tensile strength, lower resin content, and improved voltage endurance.

Untwisted yarns are flatter than twisted yams when woven into a fabric, and the fabric is thinner than a fabric composed of twisted yams. This means that for a given final thickness of a typical glass fabric/mica paper composite, one can add more mica paper to the construction. Since it is the mica paper that provides the desired characteristics of the insulating composite, it may be desirable to increase the mica content substantially. For example, a typical construction would be 2 mils of glass fabric and 3 mils of mica paper. Using fabric composed of untwisted yam, the same construction may redesigned to 1.2 mils fabric and 3.8 mils of mica paper. This is an increase of 27% mica content. Another way to view this is to evaluate the mica to glass ratios. In the first example, the mica to glass ratio is 1.5 as compared to 3.2 for the flat yam example. Such an increase of the primary insulation component may allow motor and generator manufacturers to increase the stress on the insulation and to add more copper in the design. For a given machine size, it may allow for more power output. In other cases, it may be desirable to reduce the thickness of the insulation. Thinner wall insulation on the coils of a generator may improve the thermal conductivity and allow the unit to operate cooler, which may translate to improved operating life. By replacing a standard glass fabric with one composed of untwisted yam, a thinner insulating material may be produced, without sacrificing mechanical or electrical properties, particularly tensile strength.

Untwisted filaments do not cut each other at the weave crossover and therefore a thinner fabric typically has higher tensile strength than a fabric of the same thickness and composed of twisted yams. In the composite form, this means that the improved mica to glass ratio is not done at the sacrifice of tensile strength, as would be the case for traditional round yam based glass fabrics. This is significant in that the mica paper glass composites require a high tensile for final use by the customer.

Twist-free filaments provide significantly more surface area for bonding the fabric to the mica paper than does twisted yam based fabric. The bond at the interface between the glass fabric and the mica paper is often a point of failure during the customer application. Therefore one tries to maximize this interface bonding. The natural geometry of the untwisted yarn in the fabric yields a significantly improved bond over twisted yam-based fabrics.

The total resin content used in an electric insulating material according to the present invention to the mica paper is typically lower than in conventional materials, because the volume of the glass layer is lower. This may result in a cost reduction. In addition, a reduction in organic volume typically translates to improved voltage endurance performance of the insulation and better thermal conductivity of the insulation.

For the electric insulating material of the present invention, a mica layer is typically laminated to the glass fiber layer by means of at least one polymeric resin, and commonly two or more resins are used to bind the mica layer to the glass fabric. The polymeric resin may be a thermosetting resin, particularly an epoxy resin. In a preferred embodiment, the mica layer and the glass fabric are each impregnated with a solvent-borne epoxy resin of different molecular weight and then joined together.

The mica layer of the electric insulating material of the present invention is typically in the form of mica paper, although mica flakes, flake paper, or splittings may also be used. Muscovite or phlogopite mica are commonly available and used. The phlogopite has the higher thermal properties and coefficient of thermal expansion. The mica paper may be calcinated mica paper or water disintegrated-integrated (non-calcinated) paper. A typical manufacturing process for a calcinated paper is as follows: First, a mica ore is calcinated at, for example 700-1000° C., to remove foreign materials, and crushed into pieces of a predetermined size. Then, jet water is applied to the mica pieces, thereby producing fine mark mica particles. The mixture is blended in water, leading to a mica dispersion. Thereafter, the dispersion is subjected to a papermaking process to make a paper on a cloth and dried to obtain a mica paper. The thickness of the mica layer in the electric insulating material of the present invention typically ranges from about 2 mil (50 μm) to about 10 mil (250 μm), preferably about 2 mil. to about 6 mil (150 μm) for use in taping coils and half bars where the composite acts as the main ground insulation. For taping individual conductors, a thin tape is desirable, and in such applications, the thickness of the mica layer typically ranges from about 0.5 mil (12 μm) to about 10 mil, preferably about 1 mil. to about 4 mil (100 μm), and more preferably, from about 1 mil to about 3 mil. The thickness of the glass typically ranges from about 0.5 mil to about 10 mil, preferably about 0.8 (20 μm) to about 5 mil (125 μm). Resins for use in manufacturing the electric insulating material of the present invention are chosen according to performance criteria required by the end use, including thermal, mechanical and electric properties of the resin. For example, IEEE 275 sets forth a procedure for evaluating mechanical and electrical properties of laminates under conditions of heat aging and mechanical stress; other procedures are known in the art. Any resin system may be used as long as it is chosen using sound engineering judgement. Suitable resin systems include thermosetting epoxy resins, especially epoxy phenolic novolac resins, butadiene-based resins, polyesters, silicones, bismaleimides and cyanate esters. Examples of suitable epoxy resins include bis(3,4-epoxy-6-methyl-cyclohexyl methyl)adipate, vinyl cyclohexane dioxide, or glycidyl ethers of poly phenols epoxy resin such as bisphenol A diglycidyl ether epoxy resin, phenol formaldehyde novolac polyglycidyl ether epoxy resin, epoxy cresol novolacs or mixtures thereof. Resin content may range from about 3% to about 25% by weight, preferably from about 5% to about 18% by weight in tapes for use in a VPI process. For processes that require tapes having a higher resin content, resin content typically ranges from about 25% to about 50% by weight, preferably from about 27% to about 45% by weight.

In some embodiments, the electric insulating material of the present invention additionally contains a compound or composition capable of accelerating the curing of an epoxy-anhydride resin system. These materials are used in VPI processes where mica tapes with accelerators in them are impregnated with a VPI epoxy resin containing the acid anhydride. The accelerator is in the tape at a stoichiometric ratio based on the anhydride in the VPI epoxy resin. Typical metal accelerators include zinc napthanate, zinc octoate, copper octoate, chromium octoate, and stannous octoate. Teriary amines such as tris(dimethylaminomethyl)phenol are also effective as well as imidizoles such as ethylmethylimididole. Anhydrides in the resin can include: maleic anhydride adduct of methylcyclopentadiene (nadic methyl anhydride), nadic anhydride, hexahydrophthalic anhydride, dodecenyl succinic anhydride, phthalic anhydride and pyromellitic anhydride.

The electric insulating material of the present invention may be manufactured by any of the conventional processes known in the art. Such processes are described in U.S. Pat. No. 4,704,322, U.S. Pat. No. 4,286,010, and U.S. Pat. No. 4,374,892, the contents of which are incorporated herein by reference. A basic process for production of a mica tape according to the present invention is to impregnate the mica paper and/or the glass fabric with a resin and laminate the two.

A polymeric film, for example, a polyester or polyimide, may be included in the electric insulating materials of the present invention, usually on one or both outer surfaces thereof. A polymeric mat may also be used, in place of or in addition to, the polymeric film. A polymeric mat is typically composed of a nonwoven fabric, especially of a polyester nonwoven fabric, having a thickness of about 0.8-3 mils. The film or mat protects the layer mica from damage during taping. In addition, it may be advantageous to provide protection against corona deterioration of the insulation of individual conductors and thus, a corona resistant material may be added to insulating materials for some applications. U.S. Pat. No. 5,989,702 and Canadian Patents 1,168,857 and 1,208,325 provide examples of the addition of various compounds such as submicron sized particles of alumina or silica to polymeric compositions used to coat individual conductors or to the polymeric films. DuPont's KAPTON® CR is an example of a suitable polymeric film containing corona-resistant material. The addition of the particles of alumina or silica may also improve the heat transfer characteristics of the conductor insulation as well.

A process for manufacturing an insulated electrical conductor according to the present invention includes wrapping the electrical conductor within an electric insulating material, as described above, especially a mica tape, and heating the wrapped conductor to cure the resin. In particular, conductors such as coils for rotating electrical machines may be wound by conventional lap winding techniques and placed in a coil-forming device. A VPI process may be employed to impregnate the taped coil with a suitable insulation material such as an uncured polymeric resin to fill voids and interstices in the lapped insulation. The coil may then be heated to cure the composite coil and insulation by a polymerization process. An alternative process is to wind the coil with a mica tape in a lapping fashion, until the desired number of laps have been applied to the coil or strand, and then apply heat and pressure to the coil or strand to drive the polymeric material to gelation. During the heating and pressing operation, the viscosity of the “B” stage polymeric material in the tape typically drops initially and excess resin is squeezed from the coil by the press employed to give the coil its final shape.

For insulating individual wires using the mica paper/glass fabric composite, one can take advantage of the thin glass to produce the desired thinner insulation. Again, for the same allowed space, the thinner insulation will allow for more copper, without a reduction in the amount of mica in the insulation, which translates to more power output. In addition, because of the high tensile strength of the glass fabric, tensile strength of the composite insulation is the same as, or even higher than, conventional mica tape used as cable insulation. Twisted yam-based fabrics in mica composites cause heavy ridges in the wrapped conductors. The untwisted yam yields a smoother and thinner wrap. In the case of insulated round wire, the smooth surface is desirable when extruding over the conductor. The final extruded layer on the wire may be thinner and smoother. Resins for use in high temperature cable insulation are selected to perform under the high temperature use conditions, and are typically silicone resins, although any resin that meets performance criteria for the application may be used.

A cable, wire or conductor capable of operating at high temperatures may be prepared by wrapping a conductor such as copper wire with a mica tape according to the present invention. In some applications, the wrapped assembly may be heated to cure the resin in the mica tape. Electric insulating materials for high temperature wiring are typically based on silicone resins. U.S. Pat. Nos. 4,034,153 and 6,079,077 describe processes for manufacturing insulated cable using conventional mica tapes, and are incorporated herein by reference. It should be noted that layers of plastic film, and/or additional layers of mica tape, as described in U.S. Pat. No. 4,034,153 are necessary in a process for preparing an insulated cable according to the present invention. High temperature electrical conductors typically meet the requirements of UL 5107, 5127 or 5128, or IEC 331 or 332, and can operate at temperatures up to 450° C., and preferably up to 600° C. for appliance hook-up and lead wire, and up to 750 ° C., and preferably up to 1100° C., for power cables, command cables, signal and control cables, high temperature cables and fire resistant wiring and cables. These conductors are widely used on ships and off-shore platforms and in tunnels, steelworks, and nuclear power plants.

### EXAMPLES

### Example 1

4,086 grams of polybutadiene resin (Lithene AH, Lithium Corporation of America) having an approximate weight average molecular weight of 1,800 was dissolved in 8,172 grams of toluol containing approximately 41 grams of dicumyl peroxide curing agent to give a 33.4% by weight solids solution.

An approximately two mil thick sheet of muscovite was brought in contact with an about 1.2 mil thick GlasFab® Direct glass scrim from Dielectric Solutions and the polybutadiene resin solution roller coated onto and into the mica sheet through the glass scrim. This was followed by roller coating a polymer sealing layer comprising an isoprene-butadiene A-B-A block copolymer binder solution onto the glass scrim. The sealing layer in this particular example was cast from a solution comprising 6.7 pounds of toluene, 1.32 grams of an anti-oxidant (Irganox 101, Ciba Geigy), diallylthiodipropanate 0.66 grams, Weston 618 anti-oxidant 0.66 grams, and an isoprene-butadiene A-B-A block copolymer (Kraton 1107) 0.58 pound. The thus coated tape is platen heated from below at a platen temperature of about 375°-450° C. Following application of the coatings, the tape (Tape #1) is heat treated in a drying oven at about 325° F. to a substantially tackfree state, but in a time frame so as not to initiate cure of the polybutadiene. Upon exit from the drying oven, a layer of polyethyleneterephthlate film was applied in a thickness of about 0.25 mil to that side of the mica tape opposite the glass scrim and the composite run through heated calender rollers at about 300° F.

A second sample (Tape #2) was formed in the same manner as the first sample but including an additional layer of polyethyleneterephthlate film on the block copolymer layer of the first sample. This polyester layer was applied to the same location in this manner as the first polyester layer of the first sample. The properties of the respective tapes are shown in Table I. Both tapes had a residual solvent (toluol) content of about 0.5% by weight.

TABLE I

| | Tape #1 | Tape #2 |
|---|---|---|
| Binder Content, %: | 20-25 | 20-25 |
| Thickness: (ASTM D374, Method C) | 0.0050″ | 0.0053″ |
| Approximate Weight, lbs/sq. ft. | 0.028 | 0.031 |
| Gurley Stiffness, Mg. @ 75° F. | 500 | 600 |
| Dielectric Strength V./Mil Avg.: | 800 | 1200 |
| Bar Dielectric, KV (Half-Lap Wrap) | | |
| One Layer | 3.1 | 4.5 |
| Two Layers | 6.9 | 8.5 |
| Three Layers | 8.9 | 10.5 |
| Dissipation Factor, ° C., 1.4% | 155° | |
| (40 Volts/Mil, 2 layer laminate) | | |

Laminates based on other resin systems as described in Table II were prepared. Dissipation factor for selected laminates was determined, and is listed in the table.

TABLE II

| | | Dissipation Factor |
|---|---|---|
| | | (155° C., 40 Volts/Mil) |
| Resin System | Laminate | (ASTM D150) |
| Bisphenol A | 2 layers 0.006″ mica paper | 8.8% |
| Anhydride Cure | 1 layer polyamide paper | 14.7% |
| | 2 layers polyamide and mica | 14.5% |
| | paper | |
| Novolac Epoxy* | 4 layers 0.004″ mica paper | 4.7% |
| 3% BF₃ 400 MEA | | |
| Novolac Epoxy | | |
| 3% BF₃ 400 | | |
| MEA (Hot Melt) | | |
| Novolac Epoxy* (Medium Molecular | 4 layers 0.004″ mica paper | 2.6% |
| weight) 50 phr | | |
| Phenolic novolac | | |
| Novolac Epoxy* (low molecular | 4 layers 0.004″ mica paper | 8.8% |
| weight) 50 phr | | |
| Phenolic novolac | | |
| Bisphenol A Epoxy* (low molecular | 4 layers 0.004″ mica paper | 11.0% |
| weight) 50 phr | | |
| Phenolic novolac | | |
| B-staged Hydrocarbon | 4 layers 0.004″ mica paper | 0.6% |
| Elastomer (solvent solution) | | |
| B-staged Hydrocarbon | | — |
| Elastomer (Hot Melt) | | |
| Commercial hydrocarbon | | — |
| formulation** (no solvent) | | |

*These castings were all made from acetone solution of the resins
**Rated at Class 180° C.

### Example 2

### Taping Trials

Turn Insulation: ¾″×100 yd rolls is the standard packaging. The experimental tape demonstrated excellent lay-down without the strings noted with the competitive tape.

Ground insulation: 1″×30 yd rolls on one inch I.D. cores is the standard packaging. It was determined that the tape package remained stabile throughout the taping process, even at the highest tension. Again, the tape applied smoothly and with very uniform appearance.

Coils prepared using the experimental material (coil #9) and two control tapes (coil #11 and coil #8). Side plates were bolted onto the coil slot sections to simulate the impregnation restraints encountered when the coil is in the stator. All electrical testing was done with out removing the slot side plates. This does tend to give higher tip-up results and dissipation factor values. However, since all coils were being tested in the same fashion, the results can be considered relative.

The leads of the coils were energized and the dissipation factor was measured in the slot section by connecting the measuring lead to the side plates. Resin build-up was removed in all connection areas. The dissipation factor was measured at room temperature and then at elevated temperature at a stress of 2 Kv. Each leg of the coil was tested and an average of the two results are reported. The coils were allowed to come to thermal equilibrium by holding them at the measuring temperature for one hour prior to testing. The results are as follows:

Typically most combinations of material exhibit low dissipation factor at room temperature. As the temperature of the material was increased, there was generally an increase in the dissipation factor. This is a function of how well the resin in the tape has cured in conjunction with the resin in the VPI tank. In addition, it gives an indication of the general polar nature of the bonding resin in the tape itself. The optimum is to have zero increase and in practice, try to minimize this effect. Generally, if there is increasing DF, then one also sees an increasing dielectric constant. Increase dielectric constant places greater dielectric stress on void areas, which can become a site for internal corona discharge and ultimately insulation failure. The results measured on Coils # 11 and 9 are considered to be excellent and is consistent with an anhydride cured epoxy system.

In addition to measuring the dissipation factor at room temperature, the tip-up between 2 and 8 Kv was measured on each leg of each coil. This measurement was done both prior to and after ramping the coils up to 180° C. The intension of the tip-up prior to temperature exposure is to determine how well the insulation accepted the VPI resin. A high tip-up value would reflect poor impregnation due to a high void content. The tip-up after exposure to temperature would reveal problems with thermal stability as a result of out-gassing and puffing of the insulation wall. The results are as follows:

None of the coils exhibited a problem with out-gassing or puffing. They all show an improvement in the dissipation factor after exposure to 180° C. This is consistent with an insulation that receives additional cure. The tip-ups are considered normal considering the two electrode configuration. With guard electrodes, these values would be expected to be very flat. The key point is that there was no increase in the actual tip-up for the experimental material (Coil #9) and is consistent with the control.

On the coils tested for dissipation factor, the slot section plate were removed and thin 0.050″ cross sections were cut to visually observe the copper alignment, insulation lay and VPI resin fill. All coils cross section exhibited some degree of tape distortion. Part of this due to the copper alignment, lay characteristics of the tape itself and tensioning of the tape during application. All cross sections also exhibited pockets. These pockets are not voids and are actually well filled with epoxy resin. Since the resin is translucent and the samples are lit from behind, these appear deceivingly like void gaps. However, all coils were well filled with VPI resins. This aspect would be considered excellent. Copper alignment on coils 11 and 8 was much better than 9. Presumably less attention was placed on this aspect of the coil preparation due to their sample nature.

### Example 3

### Resin Content—Mica/Glass Ratio

Tapes were prepared by the process described in Example 1, using an epoxy resin system. The experimental tape differed from Control 2 only in that a Dielectric Solutions glass fabric composed of untwisted fibers was used.

TABLE III

| Property | Control 1 | Control 2 | Experimental |
|---|---|---|---|
| Glass Thickness (mils) | 2 | 2 | 1.2 |
| Mica Thickness (mils) | 3 | 6 | 5.6 |
| Glass Weight (g/m²) | 27.5 | 27.5 | 28.8 |
| Mica Weight (g/m²) | 120 | 250 | 252 |
| Resin Content (% by Weight) | 42 | 27-33 | 30 |
| Total Thickness (mil) | 7 | 10 | 9.35 |
| Tensile (lb/in) | 110 | 110 | 150 |
| Mica/glass Thickness ratio | 1.5 | 3 | 4.7 |
| Mica/glass Weight ratio | 4.4 | 9.1 | 8.7 |
| % Compression | 30 | 40 | |
| Thickness after compression per ½ | 9.8 | 12 | |
| lap layer | | | |
| Mica/glass thickness ratio after | 1.45 | 2 | |
| compression | | | |
| 60 vpm: 133 mil No. Layers | 13.5 | 11 | |
| Tg (° C.) Post Cure 10 hrs @150 | 170 | 170 | 171 |
| C. | | | |
| % DF @ 160° C. | 10.8 | 10.8 | 3.5 |

It can be seen that the experimental tape had a higher mica/glass thickness ratio, a lower resin content and a higher tensile strength than either of the controls.

1. An electric insulating material comprising a glass fiber layer and a mica layer disposed thereon, wherein the glass fiber layer comprises twist-free glass yam.

2. An electric insulating material according to claim 1, wherein the glass fiber layer is a woven glass fabric.

3. An electric insulating material according to claim 1, additionally comprising at least one polymeric resin.

4. An electric insulating material according to claim 3, wherein the polymeric resin comprises a thermosetting resin.

5. An electric insulating material according to claim 3, wherein the polymeric resin comprises at least one epoxy resin.

6. An electric insulating material according to claim 3, wherein the polymeric resin comprises at least one silicone resin.

7. An electric insulating material according to claim 3, wherein the polymeric resin content ranges from about 3% to about 25% by weight.

8. An electric insulating material according to claim 3, wherein the polymeric resin content ranges from about 5% to about 18% by weight.

9. An electric insulating material according to claim 3, additionally comprising a cure accelerator.

10. An electric insulating material according to claim 9, wherein the cure accelerator comprises a metal or an amine.

11. An electric insulating material according to claim 3, wherein the polymeric resin content ranges from about by weight about 25% to about 50% by weight.

12. An electric insulating material according to claim 3, wherein the polymeric resin content ranges from about 27% to about 45% by weight.

13. An electric insulating material according to claim 1, in the form of a tape.

14. A process for manufacturing an insulated electrical conductor, said method comprising: wrapping the electrical conductor with an electric insulating material comprising a glass fiber layer and a mica layer disposed thereon, wherein the glass fiber layer comprises twist-free glass yarn.

15. A process according to claim 14, additionally comprising heating the wrapped conductor to cure the resin.

16. A process according to claim 14, wherein the electrical conductor is a wire suitable for use in high temperature environments.

17. A process according to claim 14, wherein the electrical conductor is a coil for use in a high voltage electrical motor.

18. A process according to claim 14, additionally comprising impregnating the material with a thermosetting resin before heating the wrapped conductor.

19. A high temperature insulated wire manufactured using a process according to claim 16, wherein said wire is rated for operation at temperatures up to 450° C.

20. A high temperature insulated wire manufactured using a process according to claim 16, wherein said wire is rated for operation at temperatures up to 1100° C.

21. A high temperature insulated coil manufactured using a process according to claim 17.
